(19) United States
(12) Patent Application Publication
(10) Pub. No.: US 2012/0164869 A1
(43) Pub. Date: Jun. 28, 2012

(54) CONNECTOR FOR CONNECTING ELECTRONIC DEVICE

(75) Inventors: Kazuhiro Mizukami, Tokyo (JP); Takeshi Okuyama, Tokyo (JP); Tadashi Kumamoto, Tokyo (JP); Toshihiro Kusagaya, Tokyo (JP)

(73) Assignee: FUJITSU COMPONENT LIMITED, Tokyo (JP)

(21) Appl. No.: 13/329,396

(22) Filed: Dec. 19, 2011

(30) Foreign Application Priority Data
Dec. 28, 2010 (JP) 2010-294270

(51) Int. Cl. H01R 13/627

(52) U.S. Cl. 439/357

(57) ABSTRACT

A connector includes a connector main body that connects with another connector, a lanyard part and a latch part provided at least on one of the side planes of the connector main body, and a hook provided on the latch part and protruding outward from the connector main body. The lanyard part includes a first lanyard bent part, a straight lanyard part, and a second lanyard bent part that are sequentially arranged in a connecting direction with respect to the another connector. The latch part includes a first latch bent part, a first latch straight part, and a second latch bent part that are sequentially arranged in the connecting direction. The first lanyard bent part includes a first lanyard opening into which the first latch bent part is inserted. The second lanyard bent part includes a second lanyard opening into which the second latch bent part is inserted.

### BACKGROUND OF THE INVENTION

1. Field of the Invention

The present invention generally relates to a connector for connecting an electronic device.

2. Description of the Related Art

Connectors are used as a member for connecting, for example, electronic devices and electronic apparatuses and enabling transmission of electric signals. The connectors vary depending on the purpose of usage.

The connectors may include a pair of connectors in which one connector is connected to the other connector (e.g., a jack connector and a plug connector). For example, Japanese Registered Patent No. 3078147 discloses a jack connector and a plug connector for improving connection reliability of connectors by providing a configuration enabling one to be easily connected to the other while being capable of preventing disconnection in a case where, for example, a wire of the plug connector is inadvertently pulled away from the jack connector.

In order to prevent the disconnection by the inadvertent pulling of the wire, Japanese Registered Patent No. 3078147 discloses a configuration in which one of the jack connector and the plug connector has a claw and the other of the jack connector and the plug connector has a recess corresponding to the claw, so that the claw can attach to the corresponding recess when the jack connector and the plug connector are in a connected state.

However, with the configuration disclosed in Japanese Registered Patent No. 3078147, in a case where one of the jack connector and the plug connector is pulled with a significant amount of force, the claw may become deformed due to the amount of pulling force applied to the claw. This may result in disconnection of the jack connector and the plug connector.

### SUMMARY OF THE INVENTION

The present invention may provide a connector for connecting an electronic device that substantially eliminates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a connector for connecting an electronic device particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a connector including a connector main body configured to connect with another connector, a lanyard part and a latch part provided at least on one of the side planes of the connector main body, and a hook provided on the latch part and protruding outward from the connector main body, wherein the lanyard part includes a first lanyard bent part, a straight lanyard part, and a second lanyard bent part that are sequentially arranged in a connecting direction with respect to the another connector, wherein the latch part includes a first latch bent part, a first latch straight part, and a second latch bent part that are sequentially arranged in the connecting direction, wherein the first lanyard bent part includes a first lanyard opening into which the first latch bent part is inserted, wherein the second lanyard bent part includes a second lanyard opening into which the second latch bent part is inserted.

Other objects and further features of the present invention will be apparent from the following detailed description when read in conjunction with the accompanying drawings.

### BRIEF DESCRIPTION OF THE DRAWINGS

FIG. 1 is a schematic diagram illustrating a first connector and a second connector according to the first embodiment of the present invention;

FIG. 2 is a top view illustrating a connected state between the first and the second connectors according the first embodiment of the present invention;

FIG. 3 is a perspective view of the first connector according to the first embodiment of the present invention;

FIG. 4 is a side view of the first connector according to the first embodiment of the present invention;

FIG. 5 is a top view of the first connector according to the first embodiment of the present invention where a bottom cover is removed;

FIG. 6 is a partial cross-sectional view of the first connector taken along a dash-dot line 5A-5B of FIG. 5;

FIG. 7 is a perspective view of a lanyard part and a latch part of the first connector according to the first embodiment of the present invention;

FIG. 8 is a schematic diagram for describing a method for locking a connected state of the first and the second connectors according to the first embodiment of the present invention (part 1);

FIG. 9 is a schematic diagram for describing a method for locking a connected state of the first and the second connectors according to the first embodiment of the present invention (part 2);

FIG. 10 is a schematic diagram for describing a method for locking a connected state of the first and the second connectors according to the first embodiment of the present invention (part 3);

FIG. 11 is a top view of the lanyard part according to the modified example of the first embodiment;

FIG. 12 is a rear perspective view of the lanyard part according to the modified example of the first embodiment;

FIG. 13 is a perspective view illustrating an assembled state of the lanyard part and the latch part according to the modified example of the first embodiment;

FIG. 14 is a perspective view illustrating a disassembled state of the lanyard part and the latch part according to the modified example of the first embodiment;

FIG. 15 is a perspective view illustrating a part of the first connector main body (top cover) in a state prior to having the lanyard part and the latch part assembled thereto according to the modified example of the first embodiment;

FIG. 16 is a partial top view illustrating a part of the first connector main body (top cover) in a state prior to having the lanyard part and the latch part assemble thereto according to the modified example of the first embodiment;

FIG. 17 is a perspective view illustrating a part of the first connector main body having the lanyard part and the latch part assembled thereto according to the modified example of the first embodiment;

FIG. 18 is a top view illustrating the assembled state of FIG. 17 according to the modified example of the first embodiment;

FIG. 19 is a perspective view illustrating the first connector in a locked connected state where a bottom cover is removed according to the modified example of the first embodiment;

FIG. 20 is a top view of the first connector in a locked connected state according to the modified example of the first embodiment;

FIG. 21 is a cross-sectional view of the first connector in the locked connected state taken along a dash-dot line 20A-20B according to the modified example of the first embodiment;

FIG. 22 is a perspective view illustrating the first connector in a released state where a bottom cover is removed according to the modified example of the first embodiment;

FIG. 23 is a top view of the first connector in a released state according to the modified example of the first embodiment; and

FIG. 24 is a cross-sectional view of the first connector in a released state taken along a dash-dot line 23A-23B according to the modified example of the first embodiment.

### DESCRIPTION OF THE PREFERRED EMBODIMENTS

In the following, embodiments of the present invention will be described with reference to the accompanying drawings.

### First Embodiment

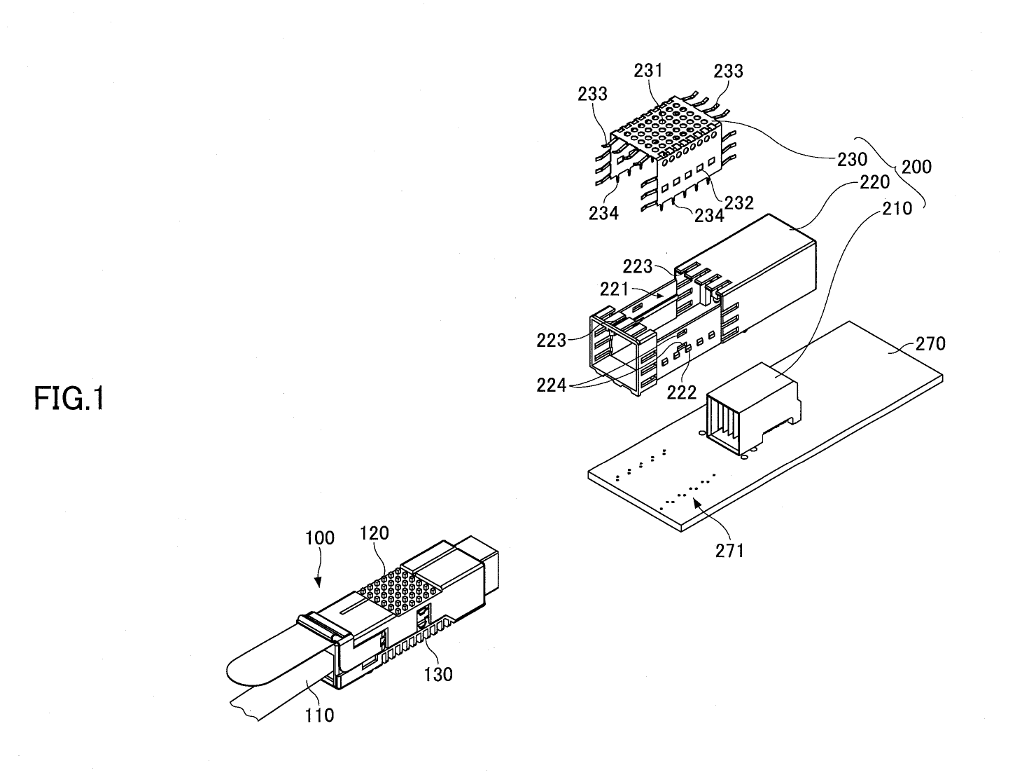

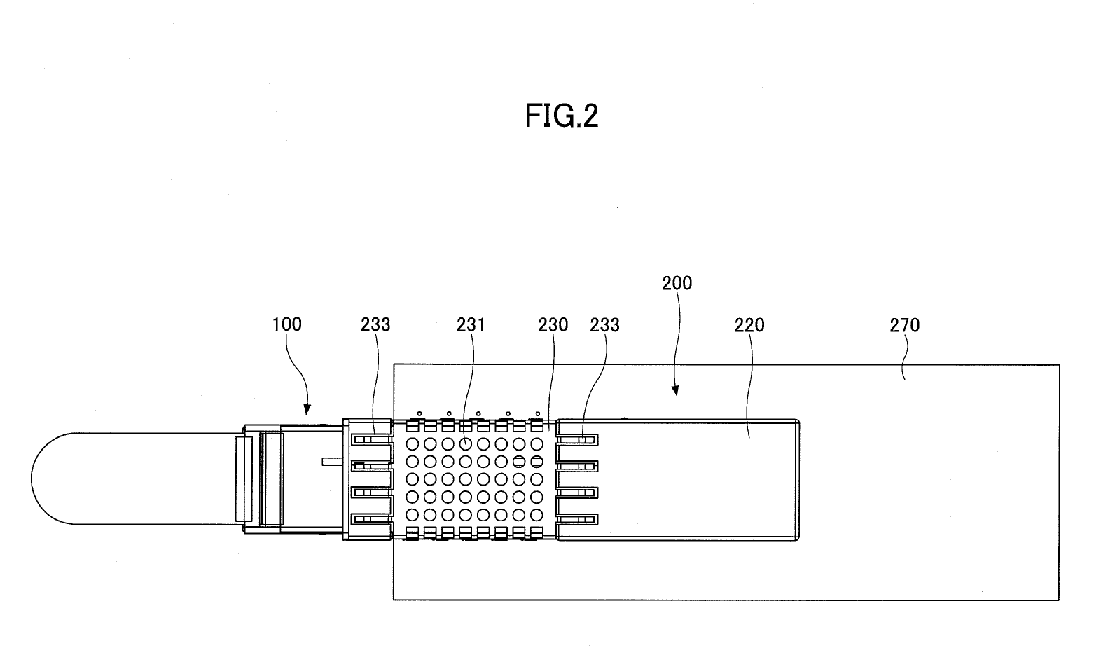

FIGS. 1 and 2 are schematic diagrams illustrating a first connector 100 and a second connector 200 according to the first embodiment of the present invention. The first connector 100 can be electrically connected to the second connector by being connected to a second connector main body 210 of the second connector 200. In this embodiment, the second connector 200 is to be connected to a substrate 270. By connecting the first and the second connectors 100, 200, electric signals can be transmitted at high speed. FIG. 2 is a top view illustrating a connected state between the first and the second connectors 100, 200.

In addition to including the second connector body 210 being connected to the substrate 270, the second connector 200 also includes a cage part 220 and a pressure part 230. When the first and the second connectors 100, 200 are in a connected state, the cage part 220 covers substantially the entire side plane of the first and the second connectors 100, 200, and the pressure part 230 is attached to the cage part 220.

The first connector 100 has a substantially rectangular parallelpiped shape. A cable 110 is connected to the first connector 100 on the side opposite of the plane for connecting to the second connector main body 210. A first heat releasing part 120 is provided on a top plane of the first connector 100 and a second heat releasing part 130 is provided on a bottom plane of the first connector 100.

The second connector main body 210 has a housing including a connection terminal(s) for electrically connecting to a corresponding connection terminal(s) of the first connector 100. The second connector main body 210 has a substantially rectangular parallelpiped shape. Among the 6 planes of the substantially rectangular parallelpiped shape of the second connector main body 210, the bottom plane (first plane) is connected to the substrate 270. More specifically, a signal terminal (not illustrated) and a ground (GND) terminal, which are provided on the first plane of the second connector main body 210, are inserted to corresponding holes formed in the substrate 270 and connected to the substrate 270 by, for example, soldering.

Assuming that the bottom plane of the second connector main body 210 is the plane connected to the substrate 270, the second connector main body 210 has four side planes in which at least one of the four side planes is connected to the first connector 100. Accordingly, the first connector 100 can be connected to the second connector main body 210 by moving the first connector 100 in a direction substantially parallel to the substrate 270.

The cage part 220, which is provided for preventing EMI (Electro-Magnetic Interference), has a substantially quadrangular cylindrical shape. The cage part 220 is attached to the second connector main body 210. Because the cage part 220 is formed with a die cast of an alloy of, for example, aluminum, zinc and has a substantially amount of thickness, the cage part 220 can be prevented from deforming and wobbling in a state where the second connector main body 210 and the first connector 100 are connected. The cage part 220 is configured to cover substantially the entire side planes of the first and the second connectors 100, 200 in a state where the first and the second connectors 100, 200 are connected. An opening 221 is formed at an upper plane of the cage part 220 in correspondence with the heat releasing parts 120 of the first connector 100 in a state where the second connector main body 210 and the first connector 100 are connected. Plural protruding parts 222 are formed at a part of the side plane of cage part 220 communicating with the opening 221. The protruding parts 220 are for securing the position of the pressure part 230. Plural groove parts 223 are provided at the upper plane of the cage part 220 and the two side planes of the cage part 220 communicating with the upper plane. The groove parts 223 are formed extending in a direction in which the second connector main body 210 and the first connector 100 are connected. Further, openings 224 are also provided on both side planes of the cage part 220 for securing the position of the first and the second connectors 100, 200, so that the first and the second connectors 100, 200 can be prevented from detaching from each other.

The pressure part 230 is formed by processing a metal plate. For example, by bending the metal plate, the pressure part 30 can be formed having 3 planes. The pressure part 230 has plural heat releasing holes 231 for releasing heat from the heat releasing part 120 of the first connector 100 in a state where the second connector main body 210 and the first connector 100 are connected. Further, the pressure part 230 includes plural fixing holes 132 provided in correspondence with the positions of the protruding parts 222 of the cage part 220. By inserting the protruding parts 222 of the cage part 220 into corresponding fixing holes 232, the pressure part 230 and the cage part 220 can be fixed to each other.

The pressure part 230 also includes plural spring parts 233 provided in correspondence with the positions of the groove parts 223 of the cage part 220. The spring parts 233 can contact the outer side of the first connector 100 by connecting the first and the second connectors 100, 200 in a state where the cage part 220 is attached to the second connector main body 210 by having the pressure part 230 and the cage part 220 fixed to each other. It is to be noted that the outer side of the first connector 100 becomes ground potential by contacting the spring parts 233 to the outer side of the first connector 100 because the pressure part 230 is grounded. The pressure part 230 also includes plural press fits 234 provided toward the side of the pressure part 230 to be connected to the substrate 270. The pressure part 230 is fixed to the substrate 270 by engaging the press fits 234 to corresponding holes 271 of the substrate 270.

### (Locking Mechanism of the First Connector 100)

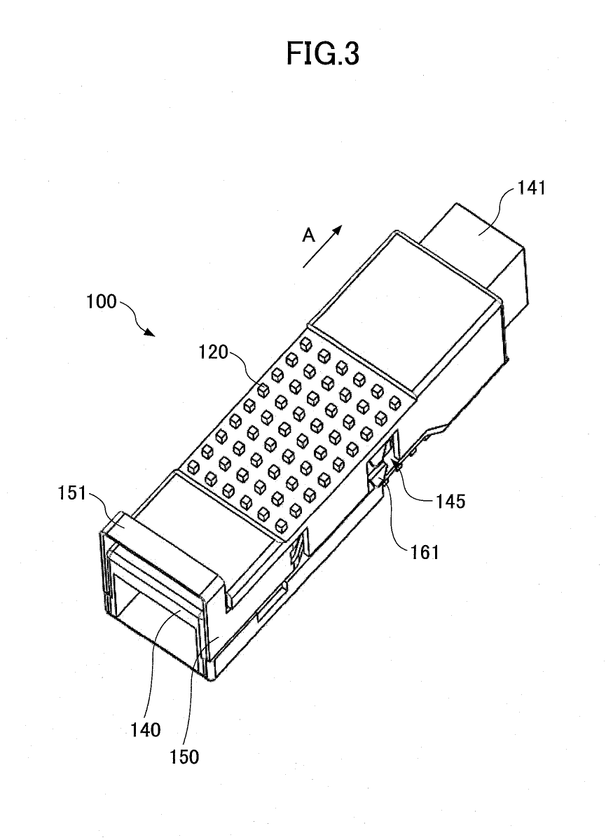

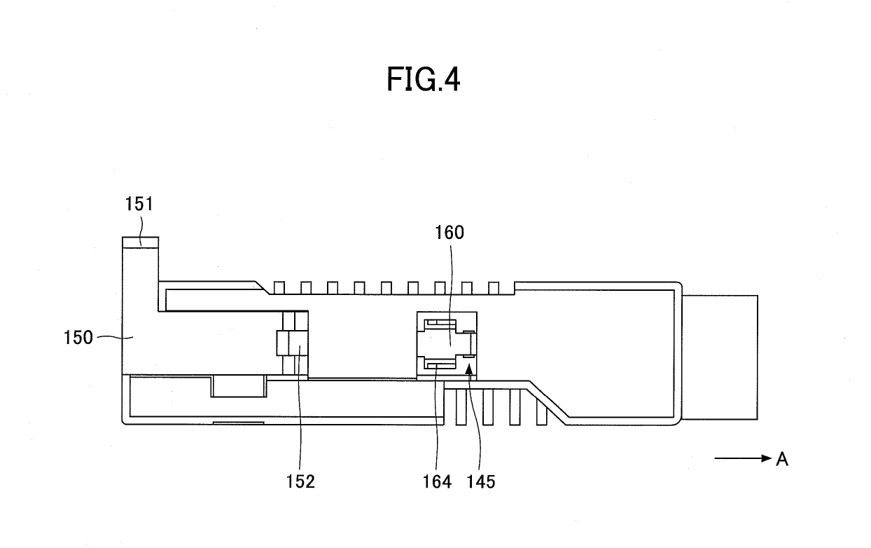

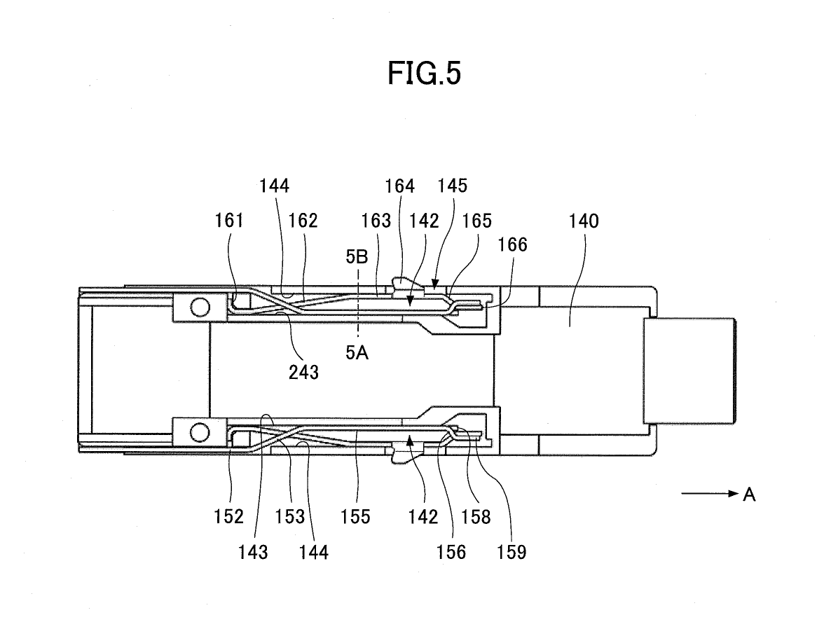

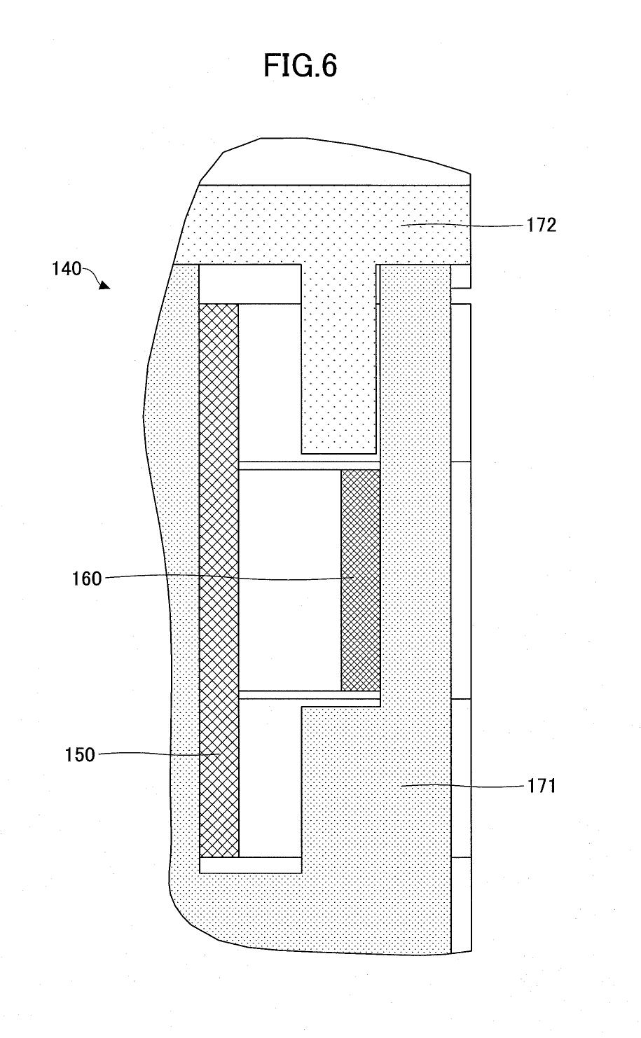

Next, the first connector 100 according to an embodiment of the present invention is described with reference to FIGS. 3 to 6. FIG. 3 is a perspective view of the first connector 100 according to an embodiment of the present invention. FIG. 4 is a side view of the first connector 100 according to an embodiment of the present invention. FIG. 5 is a top view of the first connector 100 according to an embodiment of the present invention where a bottom cover 172 is removed. FIG. 6 is a partial cross-sectional view of the first connector 100 taken along a dash-dot line 5A-5B of FIG. 5. The first connector 100 includes a first connector main body 140 formed of, for example, a resin material or a metal material. The first connector 100 is connected to the second connector 200 with a connecting part 141. In connecting the first and the second connectors 100, 200, the first connector 100 is moved in the arrow direction A relative to the first connector 100. Therefore, in this embodiment, the arrow direction A may also be referred to as a connector connecting direction. As illustrated in FIG. 6, the first connector main body 140 includes a top cover 171 and a bottom cover 172. The movement of the below-described latch parts 160 in the vertical direction is constrained by the top and the bottom covers 171, 172.

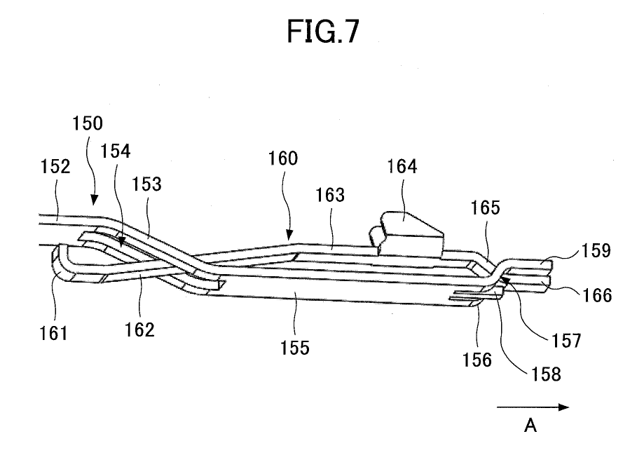

The first connector 100 has a locking mechanism includes at least a latch part 160 and a lanyard part 150 as illustrated in, for example, FIG. 7. In the embodiment illustrated in, for example, FIGS. 3, 4, 7, and 11, the first connector 100 includes two latch parts 160 and one lanyard part 150. The lanyard part 150 may have a U-shape formed of two members extending in the connector connecting direction (arrow direction A) and being coupled to each other via a lanyard coupling part 151. In the embodiment illustrated in FIG. 7, each of the two members of the lanyard part 150 includes a first straight part 152, a first bent part 153, a second straight part 155, a second bent part 156, a protruding part 158, and a terminating part 159 that are arranged in this order in the connector connecting direction (arrow direction A) from the side of the lanyard coupling part 151.

The first straight part 152 has a straight shape extending in the connector connecting direction (arrow direction A) and is positioned at the outer side of the first connector main body 140. The first bent part 153 is bent toward the inner side of the first connector main body 140. A first opening 154 is formed in the first bent part 153. The second straight part 155 has a straight shape extending in the connector connecting direction (arrow direction A). The second bent part 156 is bent toward the outer side of the first connector main body 140. A second opening 157 is formed in the second bent part 156. The protruding part 158 is provided in a portion of the second opening 157. The protruding part 158 is formed having a straight shape and extending in the connector connecting direction (arrow direction A). The terminating part 159 is also formed having a straight shape and extending in the connector connecting direction (arrow direction A).

Further, the latch part 160 includes a fixing part 161, a first bent part 162, a first straight part 163, a second bent part 165, and a second straight part 166 that are arranged in this order (i.e. order of 161, 162, 163, 165, and 166)in the connector connecting direction (arrow direction A) from a first end of the latch part 160 to a second end of the latch part 160. The latch part 160 is fixed to the first connector main body 140 by the fixing part 161 formed on the first end of the latch part 160. Therefore, the latch part 160 is bent so that the fixing part 161 is positioned substantially perpendicular to the horizontal direction of FIG. 7. The first bent part 162 is bent toward the outer side of the first connector main body 140. The first bent part 162 is formed having a thickness that allows the first bent part 162 to be inserted into the first opening part 154 of the lanyard part 150. The first straight part 163 has a straight shape and extends in the connector connecting direction (arrow direction A). A hook 164 is provided in the first straight part 163 in a manner protruding toward the outer side of the first connector main body 140. The second bent part 165 is bent toward the inner side of the first connector main body 140. The second bent part 165 is formed having a thickness that allows the second bent part 165 to be inserted into the second opening part 157 of the lanyard part 150. The second straight part 166 has a straight shape and extends in the connector connecting direction (arrow direction A).

The lanyard part 150 and the latch part 160 are assembled in a manner that the first bent part 162 of the latch part 160 is inserted into the first opening part 154 of the lanyard part 150, and that the second bent part 165 of the latch part 160 is inserted into the second opening part 157 of the lanyard part 150. Accordingly, the first bent part 162 of the latch part 160 can move inside the first opening part 154 of the lanyard part 150, and the second bent part 165 of the latch part 160 can move inside the second opening part 157 of the lanyard part 150. Further, in this assembled state, the fixing part 161 and the second straight part 163 of the latch part 160 are positioned in the inner side of the lanyard part 150 whereas the first straight part 163 of the latch part 160 is positioned in the outer side of the lanyard part 150.

As illustrated in FIG. 5, a groove part 142 is provided on both sidewalls of the first connector main body 140 along the connector connecting direction (arrow direction A). A part of the lanyard part 150 and the latch part 160 are positioned inside the groove part 142. In other words, the groove part 142 is defined as an area surrounded by an inner wall 143 of the inner side the first connector main body 140 and an outer wall 144 of the outer side of the first connector main body 140.

The second straight part 155 of the lanyard part 150 contacts the inner wall 143 in a state where a part of the lanyard part 150 and the latch part 160 are positioned inside the groove part 142 and the connection between the first and the second connectors 100, 200 are secured (locked). Further, the first straight part 163 of the latch part 160 contacts the inner side of the outer wall 144 in the state where a part of the lanyard part 150 and the latch part 160 are positioned inside the groove part 142 and the connection between the first and the second connectors 100, 200 are locked (secured). An opening 145 is formed in the outer wall 144 for enabling the hook 164 provided in the first straight part 163 to protrude toward the outer side of the outer wall 144. The hook 164 is configured to lock (secured) the connected state between the first and the second connectors 100, 200 by enabling the tip of the hook 164 to be inserted into the opening 224 of the second connector 200 as illustrated in, for example, FIG. 1. It is to be noted that FIGS. 3-7 illustrate a state where the connection between the first and the second connectors are locked (secured).

### (Releasing of Locked State)

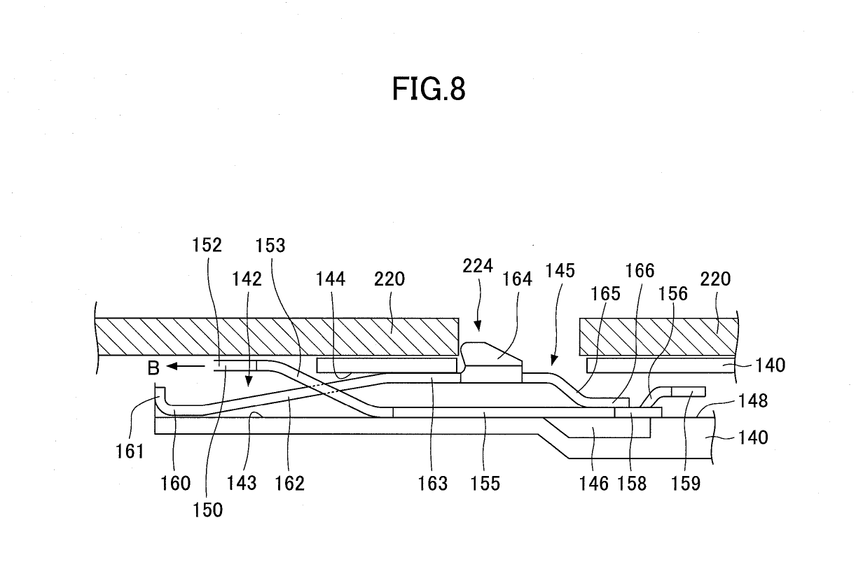

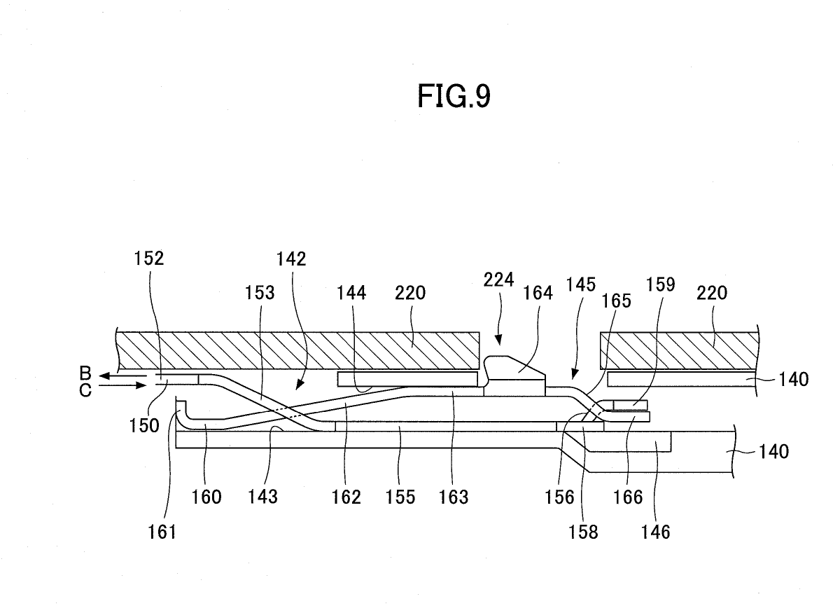

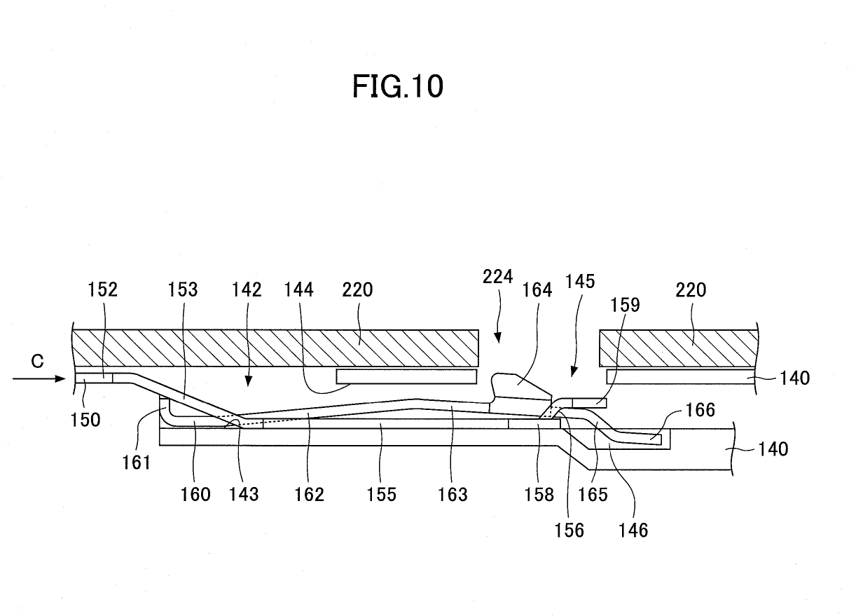

Next, an exemplary method of releasing (unlocking) the locked state of the first and the second connectors 100, 200 is described with reference to FIGS. 8 to 10. In this embodiment, the releasing is performed by moving the lanyard part 150 and the first connector main body 140 relative to each other. For example, the lanyard part 150 may be moved away from the first connector main body 140 in an arrow direction B. Alternatively, the first connector main body 140 may be moved away from the lanyard part 150 in the above-described arrow direction A. FIG. 8 is a schematic diagram illustrating a state where the connection between the first and the second connectors 100, 200 is locked. FIG. 10 is a schematic diagram illustrating a state where the locked connection between the first and the second connectors 100, 200 is released. FIG. 9 is a schematic diagram illustrating the middle of making the transition between the locked state illustrated in FIG. 8 and the unlocked state illustrated in FIG. 10.

As illustrated in FIG. 8, the second straight part 155 of the lanyard part 150 contacts the inner wall 143 of the groove part 142 of the first connector main body 140 in the state where the connection between the first and the second connectors 100, 200 is locked. Further, the first straight part 163 of the latch part 160 contacts the outer wall 144 of the groove part 142 of the second connector main body 140 in the state where the connection between the first and the second connectors 100, 200 is locked. Further, the second straight part 166 of the latch part 160 contacts the outer side of the second straight part 155 of the lanyard part 150 in the state where the connection between the first and the second connectors 100, 200 is locked. Further, in the state where the connection between the first and the second connectors 100, 200 is locked, the hook 164 of the latch part 160 protrudes from the opening 145 toward the outer side of the first connector main body 140, so that the hook 164 enters the opening 224 of the cage part 220 of the second connector 200. In this locked state, a tip of the protruding part 158 contacts an inner portion 148 of the first connector main body 140, so that the latch part 160 is firmly supported via the second straight part 166. Accordingly, the connected state between the first and the second connectors 100, 200 is locked.

As illustrated in FIG. 9, by moving the lanyard part 150 toward the arrow direction B from the state illustrated in FIG. 8, the first bent part 162 of the latch part 160 moves inside the first opening 154 of the lanyard part 150 (see FIG. 7), and the second bent part 165 of the latch part 160 moves inside the second opening 157 of the lanyard part 150. Thereby, the protruding part 158 of the lanyard part 150 is in a state contacting an end part of the second straight part 166 of the latch part 160. In this state, the hook 164 of the latch part 160 still protrudes from the opening 145 toward the outer side of the first connector main body 140 and positioned inside the opening 224 of the cage part 220 of the second connector 200. Therefore, the connected state between the first and the second connectors 100, 200 is maintained.

As illustrated in FIG. 10, by further moving the lanyard part 150 toward the arrow direction B from the state illustrated in FIG. 9, the first bent part 162 of the latch part 160 further moves inside the first opening 154 if the lanyard part 150, and the second bent part 165 of the latch part 160 further moves inside the second opening 157 of the lanyard part 150 while contacting the end part of the protruding part 158 of the lanyard part 150. Eventually, the latch part 160 is positioned in a state having the second straight part 166 positioned inside a wide groove area 146 (which is wider than the groove part 142) formed in the first connector main body 140. In this state, because the hook 164 of the latch part 160 enters the inside of the groove part 142, the tip of the hook 164 is positioned more inward than the outer side of the outer wall 144 of the first connector main body 140 or substantially the same position as the outer side of the outer wall 144. Thereby, the hook 164 is released from the opening 224 of the cage part 220 of the second connector 200. As a result, the locked connected state between the first and the second connectors 100, 200 is released.

### (Locking of Connected State)

Next, an exemplary method of locking the connected state between the first and the second connectors 100, 200 is described with reference to FIGS. 8 to 10. In this embodiment, the locking is performed by moving the lanyard part 150 toward the first connector main body 140 in an arrow direction C.

In a state immediately after connecting the first and the second connectors 100, 200, the connected state between the first and the second connectors 100, 200 is not locked. Therefore, as illustrated in FIG. 10, the second straight part 166 of the latch part 160 is positioned inside the wide groove area 146 of the first connector main body 140. In this state, the hook 164 of the latch part 160 enters the inside of the groove part 142, the tip of the hook 164 is positioned more inward than the outer side of the outer wall 144 of the first connector main body 140 or substantially the same position as the outer side of the outer wall 144.

Then, as illustrated in FIG. 9, by moving the lanyard part 150 toward the arrow direction C from the state illustrated in FIG. 10, the first bent part 162 of the latch part 160 moves inside the first opening 154 of the lanyard part 150 (see FIG. 7), and the second bent part 165 of the latch part 160 moves inside the second opening 157 of the lanyard part 150. Thereby, the second bent part 165 of the latch part 160 contacts the end part of the protruding part 158 of the lanyard part 150, and the second straight part 166 of the latch part 160 is raised and moved along the second bent part 165 toward the outer side of the first connector main body 140. As a result, a contacting state between an end part 159 of the lanyard part 150 and the second straight part 155 of the lanyard part 150 is established. In this contacting state, the second straight part 166 of the lanyard part 150 contacts the inner wall 143 of the groove part 142 of the first connector main body 140. Further, in this contacting state, the first straight part 163 of the latch part 160 contacts the outer wall 144 of the groove part 142 of the first connector main body 140. Further, in this contacting state, the hook 164 of the latch part 160 protrudes toward the outer side of the first connector main body 140 and enters the opening 224 of the cage part 220 of the second connector 200. As a result, the connected state between the first and the second connectors 100, 200 is locked.

Further, as illustrated in FIG. 9, by further moving the lanyard part 150 toward the arrow direction C from the state illustrated in FIG. 10, the second straight part 166 of the latch part 160 contacts the outer side of the second straight part 155 of the lanyard part 150, and the hook 164 of the latch part 160 protrudes toward the outer side of the first connector main body 140. In this state, because the hook 164 is positioned inside the opening 224 of the cage part 220 of the second connector 200, the locked connected state between the first and the second connectors 100, 200 is maintained more securely.

In this embodiment, in locking the connected state between the first and the second connectors 100, 200, the connected state between first and the second connectors 100, 200 can be locked more securely because the hook 164 is positioned between the lanyard coupling part 151 (to which a pulling force is exerted) and the second straight part 166 and also because the hook 164 is interposed between the lanyard coupling part 151 and the protruding part 158 contacting the second straight part 166 (in which the contacting point servers as a fulcrum). In other words, because the hook 164 is not formed at the end of the lanyard part 150 or the end of the latch part 160, the hook 164 cannot be easily bent. Further, as illustrated in FIG. 8, the connected state between the first and the second connectors 100, 200 can be locked more securely by moving the second straight part 166 of the latch part 160 to the inner side of the second straight part 155 of the lanyard part 150.

It is to be noted that, although the lanyard part 150 and the latch part 160 is formed with a metal material or a resin material, it is preferable to use a metal material having a high spring characteristic and being able to be formed into a thin shape.

### MODIFIED EXAMPLE

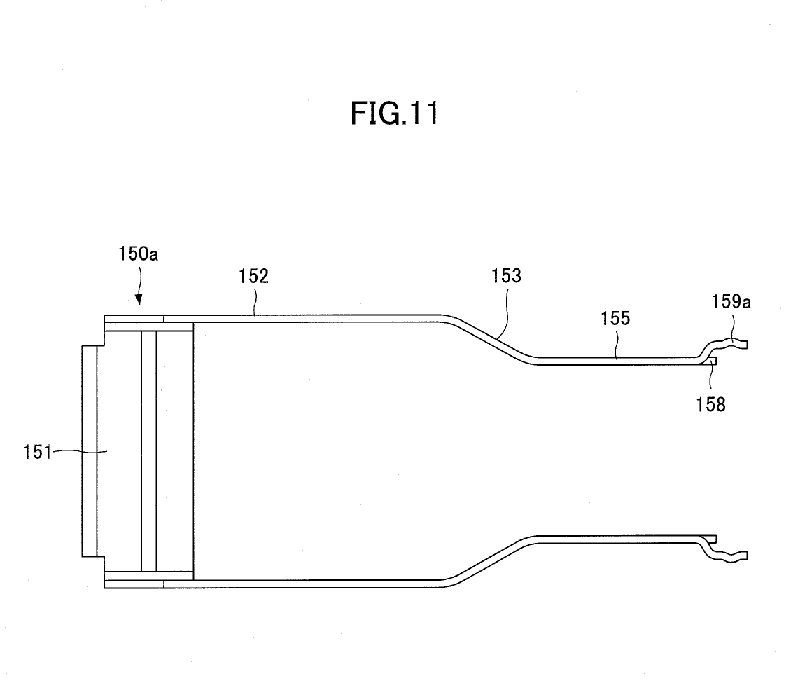

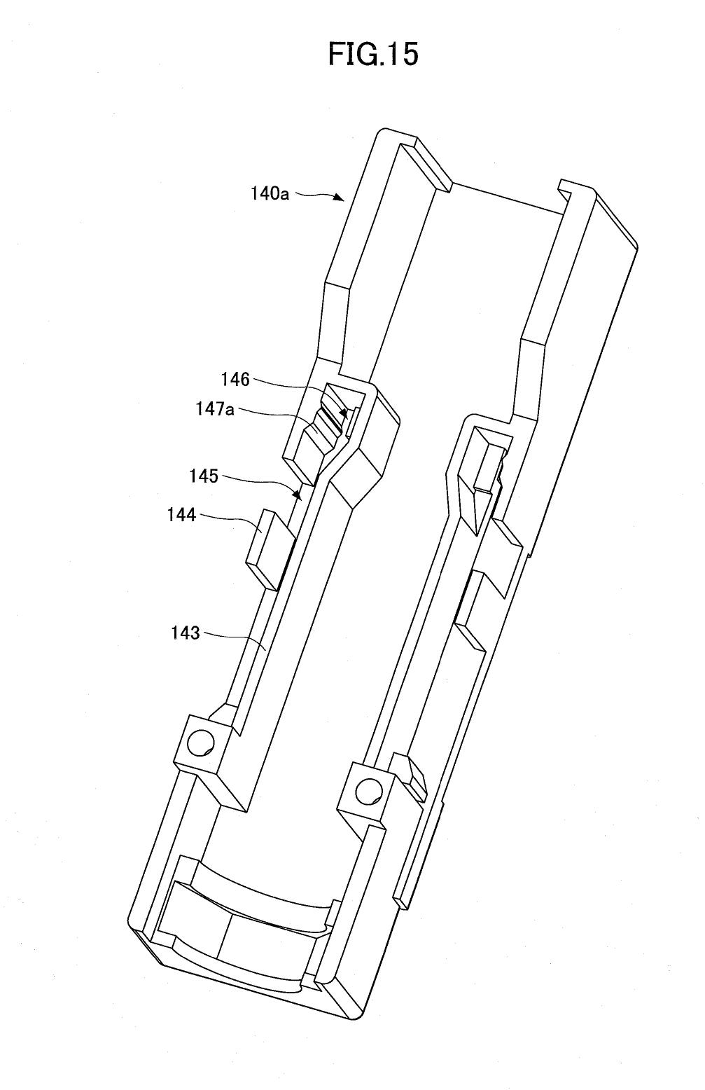

Next, a first connector 100a according to a modified example of the first embodiment of the present invention is described. In the following modified example of the first embodiment, like components are denoted by like reference numerals as those of the first embodiment and are not further explained. The first connector 100a includes a lanyard part 150a having an end part that is shaped different from that of the lanyard part 150 of the first embodiment. In the modified example of the first embodiment, the end part of the lanyard part 150a is formed in a concavo-convexo shape (hereinafter also referred to as “concavo-convexo part 159a”) for creating a clicking feel when locking the connection between the first and the second connectors 100a, 200 (see, for example, FIG. 11). The first connector main body 140a has a concavo-convexo part 147a provided in a part corresponding to the concavo-convexo part 159a (see, for example, FIG. 15). In a case of locking the connected state between the first connector 100a and the second connector 200, the concavo-convexo part 159a of the lanyard part 150a and the concavo-convexo part 147a of the first connector 100a contact each other. The contact between the concavo-convexo part 159a and the concavo-convexo part 147a causes a vibration or the like. Accordingly, the user can confirm that the first and the second connectors are locked by feeling the vibration or the like caused by the contact between the concavo-convexo part 159a and the concavo-convexo part 147a.

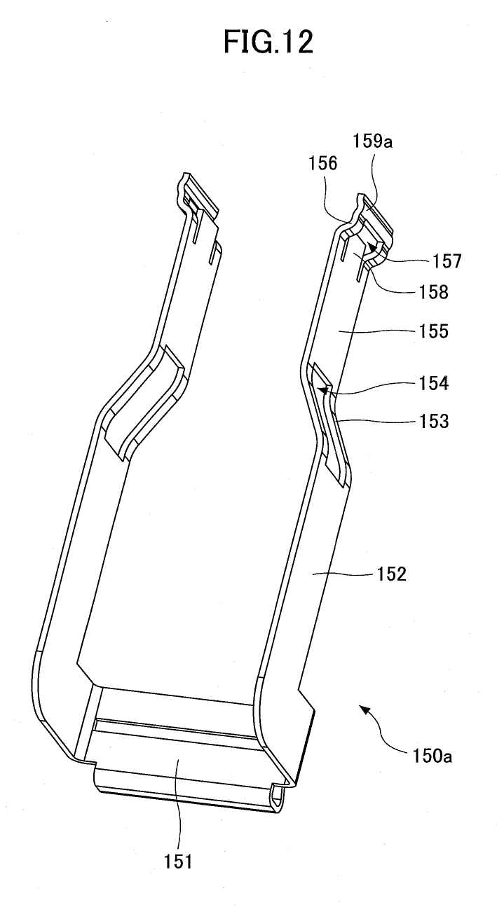

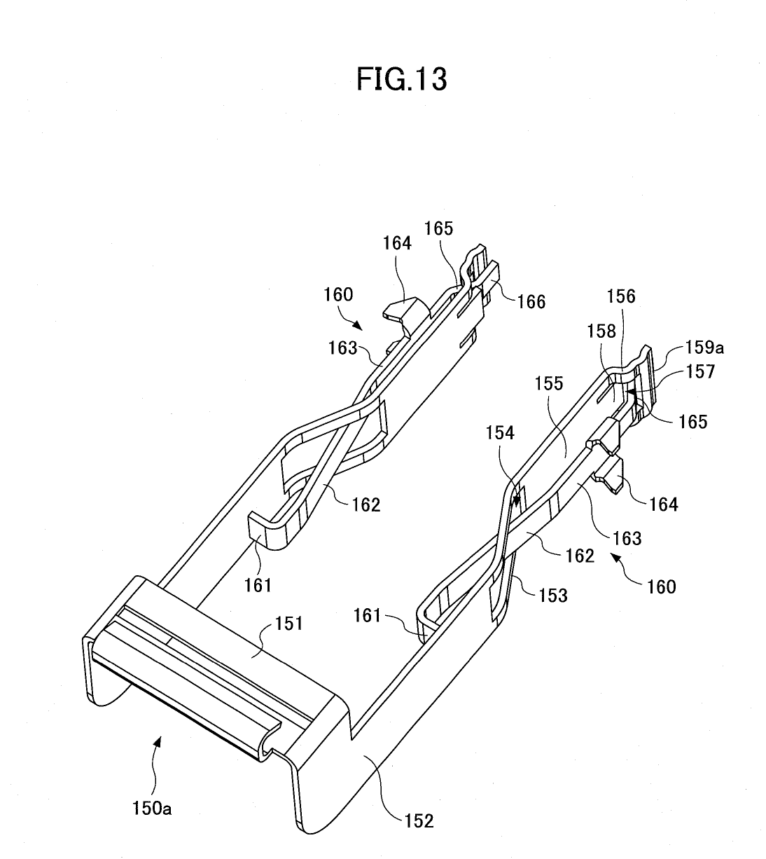

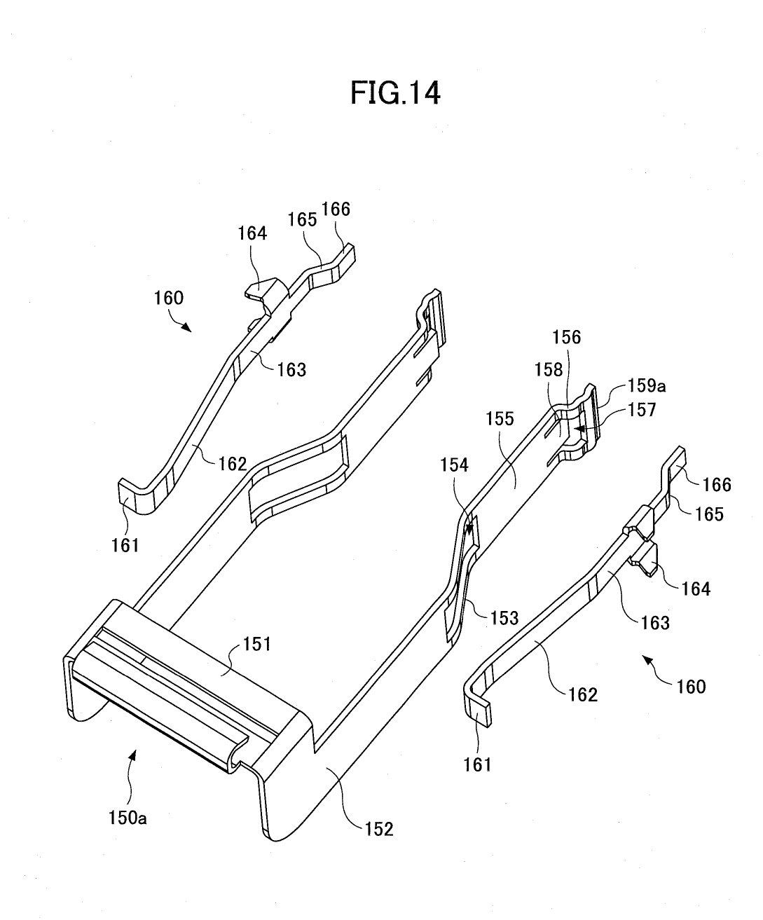

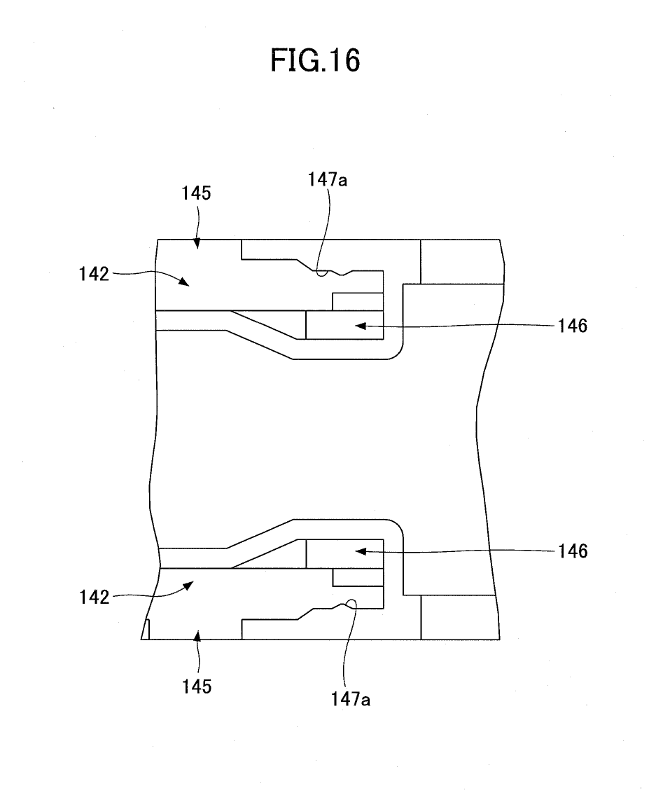

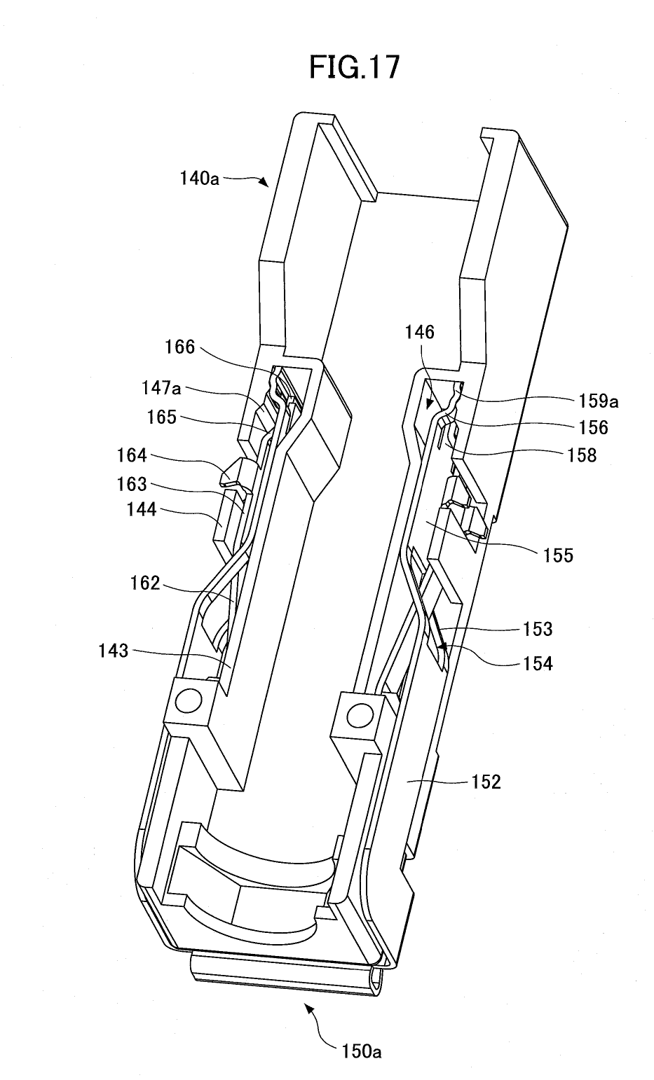

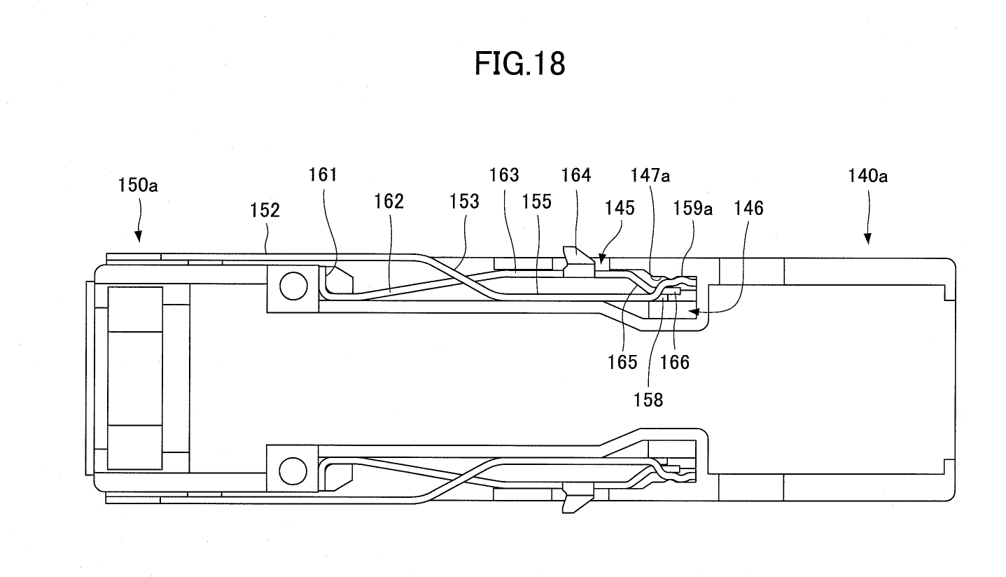

FIG. 11 is a top view of the lanyard part 150a according to the modified example of the first embodiment. FIG. 12 is a rear perspective view of the lanyard part 150a according to the modified example of the first embodiment. FIG. 13 is a perspective view illustrating an assembled state of the lanyard part 150a and the latch part 160 according to the modified example of the first embodiment. FIG. 14 is a perspective view illustrating a disassembled state of the lanyard part 150a and the latch part 160 according to the modified example of the first embodiment. FIG. 15 is a perspective view illustrating a part of the first connector main body 140a (top cover 171) in a state prior to having the lanyard part 150a and the latch part 160 assembled thereto according to the modified example of the first embodiment. FIG. 16 is a partial top view illustrating a part of the first connector main body 140a (top cover 171) in a state prior to having the lanyard part 150a and the latch part 160 assemble thereto according to the modified example of the first embodiment. FIG. 17 is a perspective view illustrating a part of the first connector main body 140a having the lanyard part 150a and the latch part 160 assembled thereto according to the modified example of the first embodiment. FIG. 18 is a top view illustrating the assembled state of FIG. 17 according to the modified example of the first embodiment.

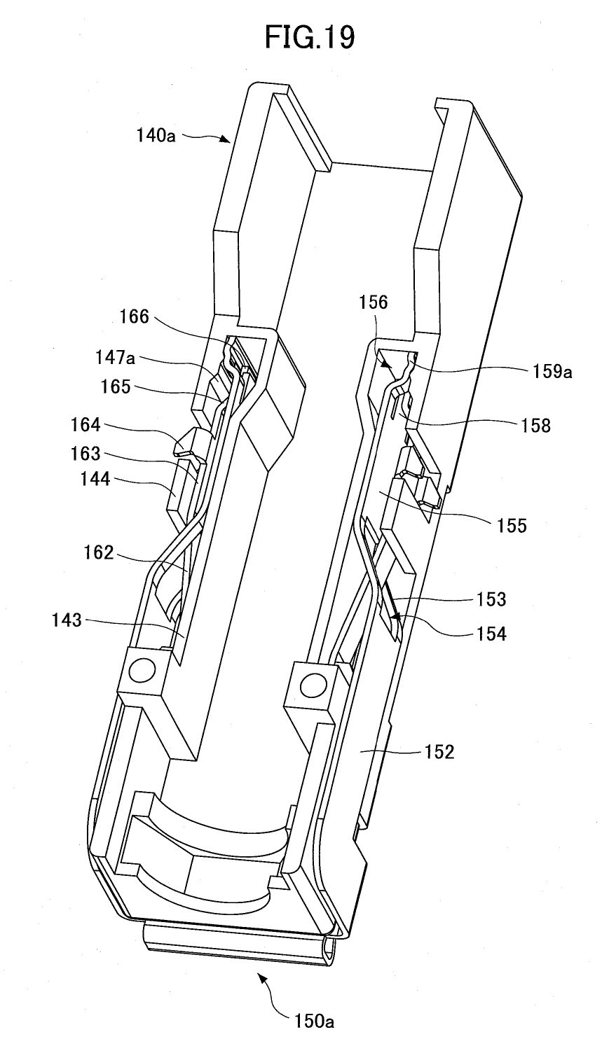

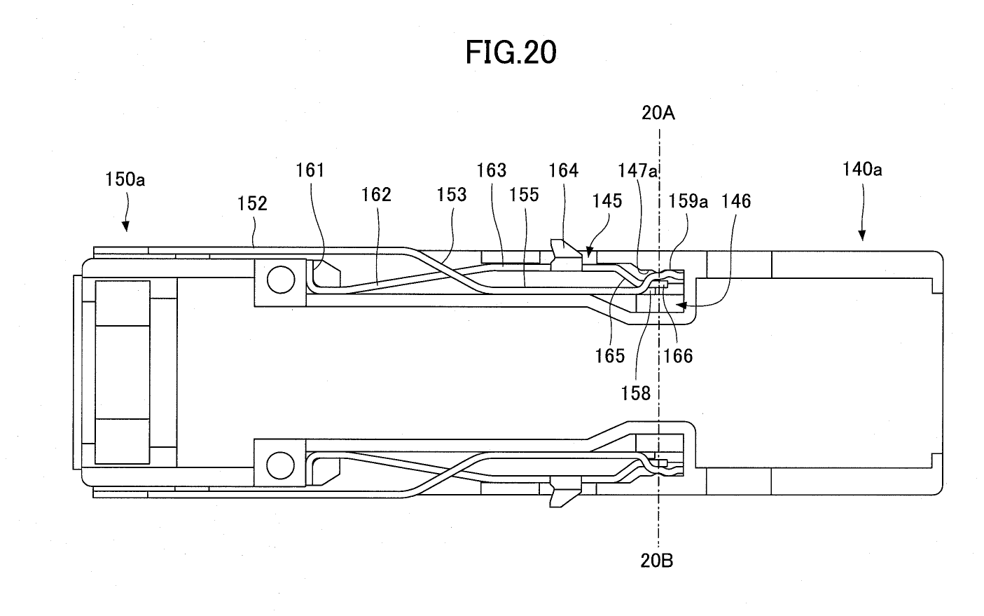

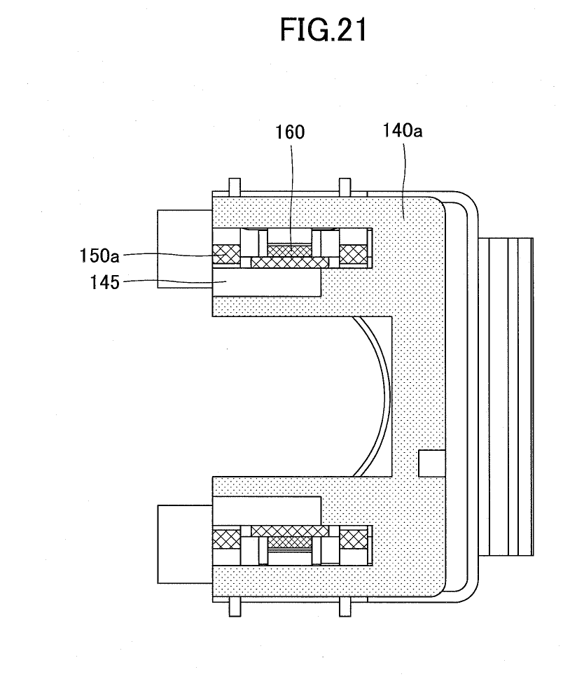

FIGS. 19-21 are diagrams illustrating the locked connected state of the first and the second connectors 100, 200a according to the modified example of the first embodiment. FIG. 19 is a perspective view illustrating the first connector 100a in the locked connected state where the bottom cover 172 is removed according to the modified example of the first embodiment. FIG. 20 is a top view of the first connector 100a in the locked connected state according to the modified example of the first embodiment. FIG. 21 is a cross-sectional view of the first connector 100a in the locked connected state taken along a dash-dot line 20A-20B according to the modified example of the first embodiment.

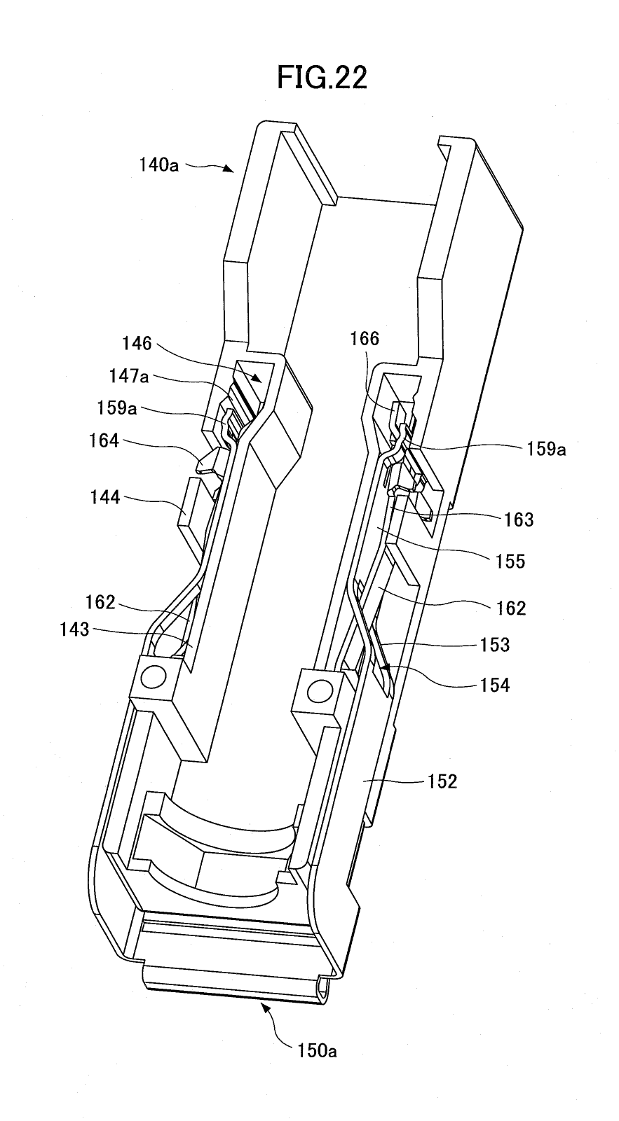

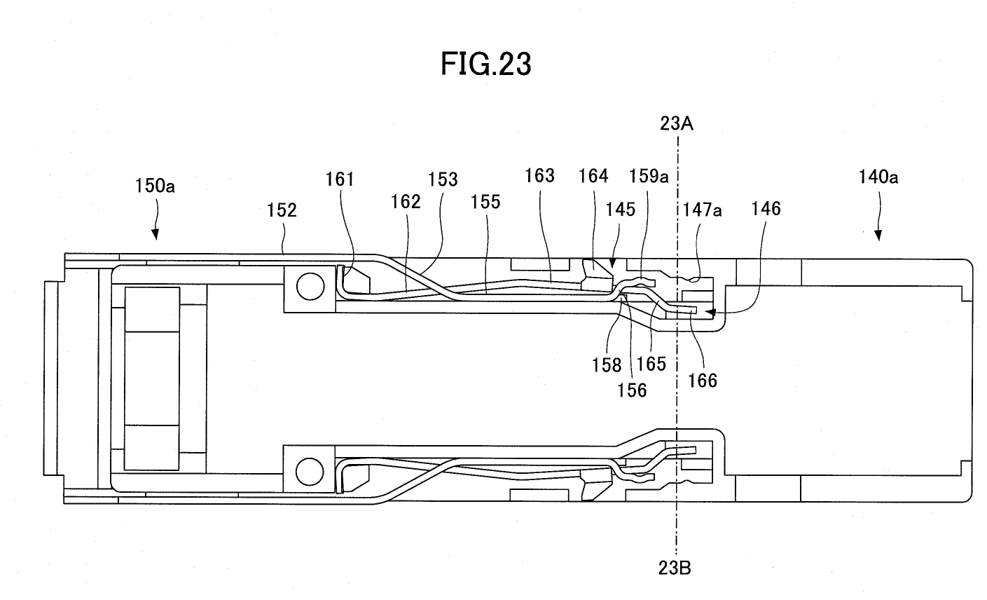

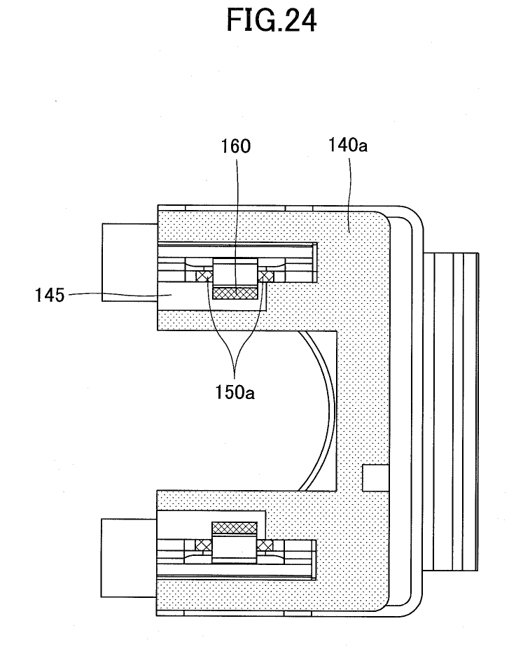

FIGS. 22-24 are diagrams illustrating the state where the locked connection between the first and the second connectors 100a, 200 is released according to the modified example of the first embodiment. FIG. 22 is a perspective view illustrating the first connector 100a in a released state where the bottom cover 172 is removed according to the modified example of the first embodiment. FIG. 23 is a top view of the first connector 100a in the released state according to the modified example of the first embodiment. FIG. 24 is a cross-sectional view of the first connector 100a in the released state taken along a dash-dot line 23A-23B according to the modified example of the first embodiment.

Accordingly, connection between the first connector 100a and the second connector 200 can be locked in substantially the same manner as that of the first embodiment. It is to be noted that details other than those described in the modified example of the first embodiment are substantially the same as the first embodiment.

Further, the present invention is not limited to these embodiments, but variations and modifications may be made without departing from the scope of the present invention.

The present application is based on Japanese Priority Application No. 2010-294270 filed on Dec. 28, 2010, with the Japanese Patent Office, the entire contents of which are hereby incorporated by reference.

What is claimed is

1. A connector comprising:
a connector main body configured to connect with another connector;
a lanyard part and a latch part provided at least on one of the side planes of the connector main body; and
a hook provided on the latch part and protruding outward from the connector main body;
wherein the lanyard part includes a first lanyard bent part, a straight lanyard part, and a second lanyard bent part that are sequentially arranged in a connecting direction with respect to the another connector;
wherein the latch part includes a first latch bent part, a first latch straight part, and a second latch bent part that are sequentially arranged in the connecting direction;
wherein the first lanyard bent part includes a first lanyard opening into which the first latch bent part is inserted;
wherein the second lanyard bent part includes a second lanyard opening into which the second latch bent part is inserted.

2. The connector as claimed in claim 1, wherein the first latch straight part is positioned more toward an outer side of the connector main body than the straight lanyard part.

3. The connector as claimed in claim 1, wherein the connector main body is configured to connect or disconnect with respect to the another connector by moving the lanyard part in a direction parallel to the connecting direction.

4. The connector as claimed in claim 1, further comprising: a lanyard coupling part;
wherein the lanyard part provided on the one of the side planes is connected to another lanyard part provided on another one of the side planes.

5. The connector as claimed in claim 1, wherein the lanyard part further includes a protruding part provided inside the second lanyard opening;
wherein the latch part further includes a second latch straight part positioned toward the connecting direction more than the second latch bent part;
wherein the protruding part is configured to lock the connection between the connector main body and the another connector by contacting the second latch straight part.

6. The connector as claimed in claim 1,
wherein the latch part further includes a second latch straight part positioned toward the connecting direction more than the second latch bent part;
wherein the second latch straight part is configured to lock the connection between the connector main body and the another connector by being positioned toward the outer side of the connector main body more than the straight lanyard part.

7. The connector as claimed in claim 1, wherein the connector main body is configured to lock a position of the hook by contacting an inner side of the straight lanyard part and supporting the lanyard part.

8. The connector as claimed in claim 1,
wherein the connector main body has a groove part provided on both of the side planes, and a wide groove area that is wider than the groove part;
wherein a portion of the lanyard part and a portion of the latch part are positioned inside the groove part;
wherein the second latch straight part is configured to be positioned inside the wide groove area when the connection between the connector main body and the another connector is not locked.

9. The connector as claimed in claim 1,
wherein the lanyard part further includes an end part positioned toward the connecting direction more than the second lanyard bent part;
wherein the end part has a concavo-convexo shape.

10. The connector as claimed in claim 1, wherein the lanyard part and the latch part are formed of a metal material.

11. The connector as claimed in claim 1, wherein the hook is configured to enter an opening formed in the another connector in a state where the connection between the connector main body and the another connector is locked.
